(19) United States
(12) Patent Application Publication
(10) Pub. No.: US 2022/0012518 A1
(43) Pub. Date: Jan. 13, 2022

(54) METHOD AND APPARATUS FOR PRESENTING OBJECT ANNOTATION TASKS

(71) Applicant: HERE Global B.V., Eindhoven (NL)

(72) Inventor: Alastair B. SUTHERLAND, Seattle, WA (US)

(21) Appl. No.: 17/090,568

(22) Filed: Nov. 5, 2020

Related U.S. Application Data
(60) Provisional application No. 63/049,451, filed on Jul. 8, 2020.

(51) Int. Cl. G06K 9/32; G06K 9/62; G06N 20/00

(52) U.S. Cl. CPC G06K 9/3241; G06N 20/00; G06K 9/6257; G06K 9/6254

(57) ABSTRACT

An approach is provided for presenting an annotation task. The approach involves, for example, selecting a designated number of one or more points in an image. The approach also involves providing data for presenting a user interface indicating the one or more points in the image comprising the designated number. The user interface provides at least one user interface element for annotating one or more objects in the image corresponding to the designated number of the one or more points during an annotation session. The approach further involves initiating an end of the annotation session based on determining that the one or more objects in the image have been annotated. The approach further involves storing the annotated one or more objects.

### RELATED APPLICATION

This application claims priority from U.S. Provisional Application Ser. No. 63/049,451, entitled “METHOD, APPARATUS, AND SYSTEM FOR PRESENTING OBJECT ANNOTATION TASKS,” filed on Jul. 8, 2020, the contents of which are hereby incorporated herein in their entirety by this reference.

### BACKGROUND

Over the past decades, massive increases in the scale and type of annotated data have accelerated advances in all areas of machine learning. This has enabled major advances in many areas of science and technology, as complex models of physical phenomena or user behavior, with millions or perhaps billions of parameters, can be fit to data sets of increasing size. The process of annotating object observations (e.g., in images) to train machine learning models (e.g., a feature detection model for detecting features or objects in images) is often the most time-consuming and expensive part of the machine learning pipeline as it generally requires human input for annotating each instance observation. However, because the number of objects or other items to label in each observation (e.g., each image) can vary greatly in number between different instances, the amount of annotation work can also vary significantly from image to image. Accordingly, service providers face significant technical challenges to evenly and efficiently assign annotation tasks.

### SOME EXAMPLE EMBODIMENTS

Therefore, there is a need for an approach for evenly and efficiently assigning annotation tasks, regardless of the number and complexity of objects to be annotated in the observations or images.

According to one embodiment, a computer-implemented method comprises selecting a designated number of one or more points in an image. The method also comprises providing data for presenting a user interface indicating the one or more points in the image comprising the designated number. The user interface provides at least one user interface element for annotating one or more objects in the image corresponding to the designated number of the one or more points during an annotation session. The method further comprises initiating an end of the annotation session based on determining that the one or more objects in the image have been annotated. The method further comprises storing the annotated one or more objects.

According to another embodiment, an apparatus comprises at least one processor, and at least one memory including computer program code for one or more computer programs, the at least one memory and the computer program code configured to, with the at least one processor, cause, at least in part, the apparatus to select a designated number of one or more points in an image. The apparatus is also caused to provide data for presenting a user interface indicating the one or more points in the image comprising the designated number. The user interface provides at least one user interface element for annotating one or more objects in the image corresponding to the designated number of the one or more points during an annotation session. The apparatus is further caused to initiate an end of the annotation session based on determining that the one or more objects in the image have been annotated. The apparatus is further caused to store the annotated one or more objects.

According to another embodiment, a non-transitory computer-readable storage medium carries one or more sequences of one or more instructions which, when executed by one or more processors, cause, at least in part, an apparatus to select a designated number of one or more points in an image. The apparatus is also caused to provide data for presenting a user interface indicating the one or more points in the image comprising the designated number. The user interface provides at least one user interface element for annotating one or more objects in the image corresponding to the designated number of the one or more points during an annotation session. The apparatus is further caused to initiate an end of the annotation session based on determining that the one or more objects in the image have been annotated. The apparatus is further caused to store the annotated one or more objects.

According to another embodiment, an apparatus comprises means for selecting a designated number of one or more points in an image. The apparatus also comprises means for providing data for presenting a user interface indicating the one or more points in the image comprising the designated number. The user interface provides at least one user interface element for annotating one or more objects in the image corresponding to the designated number of the one or more points during an annotation session. The apparatus further comprises means for initiating an end of the annotation session based on determining that the one or more objects in the image have been annotated. The apparatus further comprises means for storing the annotated one or more objects.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting an annotation task, according to one embodiment;

FIG. 2 is a diagram illustrating an example of distributing an annotation task across multiple annotation sessions, according to one embodiment;

FIG. 3 is a flowchart of a process for presenting an image annotation task, according to one embodiment;

FIGS. 4A-4G are diagrams of user interfaces for presenting annotation tasks based on an image, according to various embodiments;

FIG. 5A is a diagram of a user interface for presenting an audio annotation task, according to one embodiment;

FIG. 5B is a diagram of a user interface for presenting a trajectory annotation task, according to one embodiment;

FIG. 6 is a diagram of a geographic database, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal that can be used to implement an embodiment of the invention.

### DESCRIPTION OF SOME EMBODIMENTS

Examples of a method, apparatus, and computer program for presenting an annotation task are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to images, it is contemplated that the approach described herein may be used with other observations of a phenomenon, such as audio recordings, probe trajectories, etc., that can been manually labeled with features or characteristics identifiable by an observer.

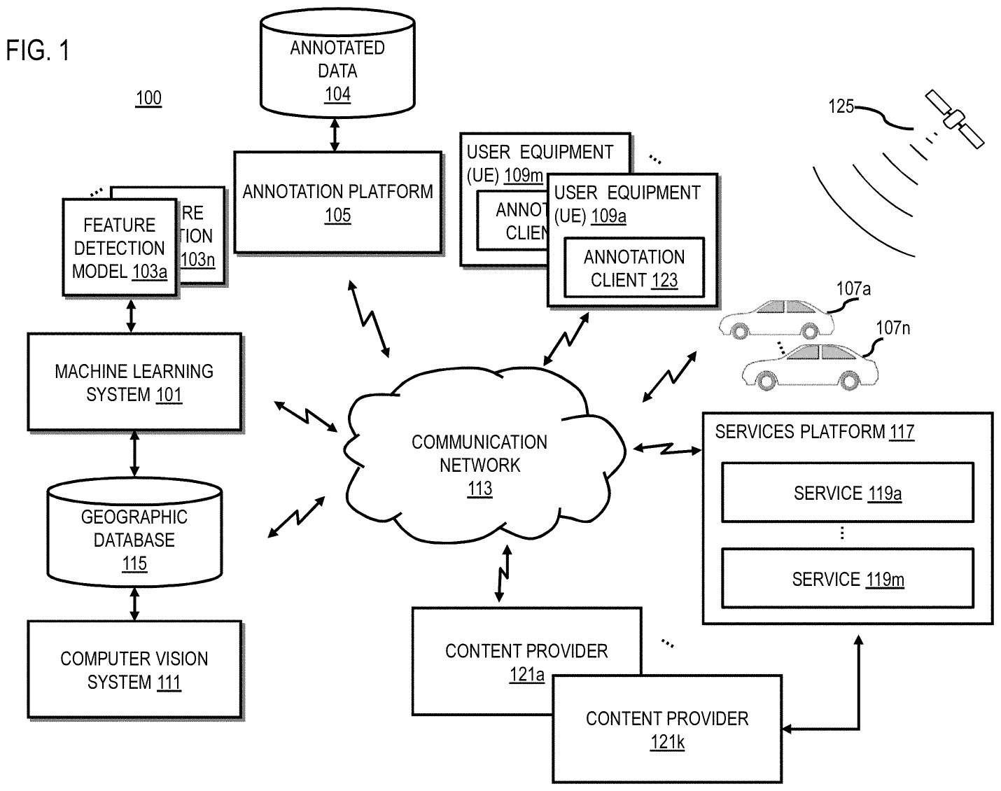

FIG. 1 is a diagram of a system 100 capable of presenting an annotation task, according to one embodiment. In one embodiment, a machine learning system (e.g., machine learning system 101) or model (e.g., feature detection models 103a-103n—also collectively referred to as feature detection models 103) can be trained using ground truth or training data (e.g., annotated data 104) containing examples of objects or features to be classified by the machine learning model. The annotated data 104 (e.g., ground truth or training data) include observations that have been annotated with labels that are known or accepted to be true by a human annotator. Because of the need for human or manual labor, data annotation tasks can be expensive and resource intensive. For example, a machine learning model can be trained to recognize objects or features that are visible in image data (e.g., images and/or videos), and will need to have a significant amount of training data with ground truth annotations of these objects or features. In a mapping or navigation use case, objects such as buildings, vehicles, pedestrians, obstacles, and/or the like can be important to detect and recognize in imagery captured, for instance, by vehicles as they travel in a road network. This means that human annotators must be assigned images in which they must identify and annotate the requested buildings, vehicles, etc.

However, the amount of annotation work can vary wildly from image to image (or observation to observation). This is because the number and/or complexity of objects of interest that are visible in a given observation or image can vary significantly between images. For example, some images may depict no buildings or dozens of buildings. Some images may depict a building occupying more than half the image, and yet other images have buildings so far away that it may be unclear to the annotator whether the buildings are worth annotating.

Under a traditional approach, annotation tasks using human labor are assigned (and paid) as piecework. In other words, a worker is assigned an image to label as a whole without regard to the number of annotations that may be required in the assigned image. This can lead to inconsistencies in the amount of human effort that is expended for annotating different images. Therefore, service providers face significant technical challenges to resolving this inter-image/inter-observation inconsistency. For example, consistency in the amount of work per task (e.g., per image when each image is a task) is important for the service provider to properly estimate both the scope of work and price for an annotation job, and also for the workers in feeling that their work is fairly compensated and assigned, both before and after deciding to perform the annotation work.

To address these technical challenges, a system 100 of FIG. 1 introduces a capability to divide a task for annotating an observation (e.g., an image) across multiple annotation sessions based on a designated number of objects or items to be annotated in a given annotation session. In one embodiment, each annotation session can then be assigned to a worker (e.g., a human annotator) so that each worker will have to annotate no more than the designated number objects to complete an annotation session. By breaking the traditional piecework annotation task into annotation sessions of a known or designated numbers of objects/items to annotate, the system 100 advantageously increases the consistency and predictability of annotation tasks from both the service provider side and the worker side.

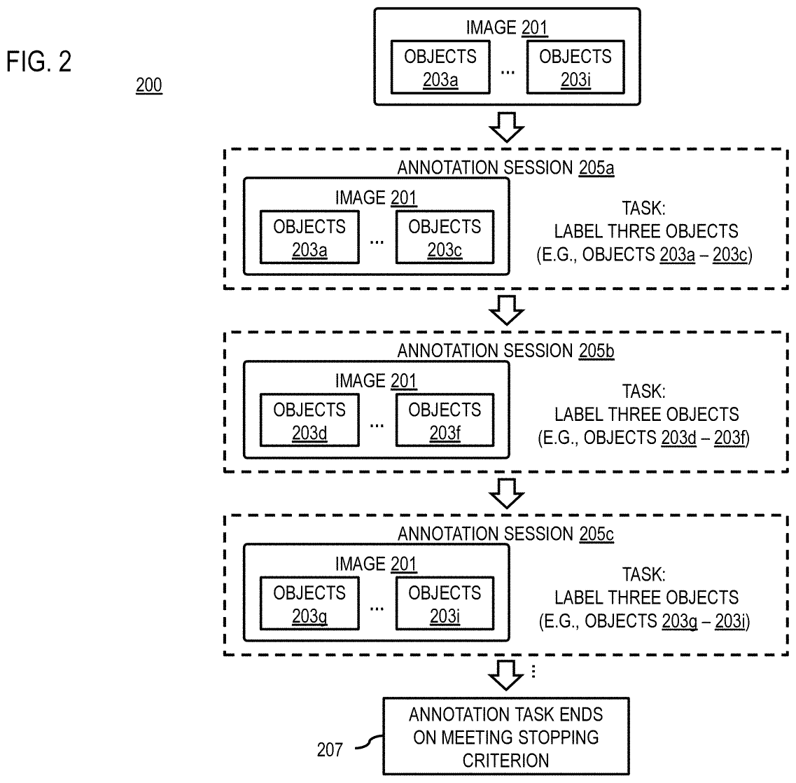

FIG. 2 illustrates an example 200 of distributing an annotation task across multiple annotation sessions, according to one embodiment. In this example, an image 201 contains 9 objects that are to be annotated (e.g., objects 203a-203i), and the annotation platform 105 is configured to request annotation of a designated number of the objects 203a-203n (e.g., 3 objects) to annotate in each session. Accordingly, the annotation platform 105 can divide the task of annotating the image 201 into three annotation sessions 205a-205c as follows: in annotation session 205a, an annotator is requested to label three objects (e.g., objects 203a-203c) to complete the annotation session 205a; in annotation session 205b, an annotator is requested to label another three objects (e.g., 203d-203f) to complete the annotation session 205b; and in annotation session 205c, an annotator is requested to label the final three objects (e.g., 203g-203i) to complete annotation session 205c. Each annotation session 205a-205c can be assigned independently to one or more workers. In one embodiment, after one annotation session is completed for the image 201, new points are selected from the remaining objects or areas of the image 201 that have not already been marked as an object instance. The next session can then be presented to the same or a new worker. As a result, the system 100 balances any variation in the number of objects between observations or images across sessions with a known or designated number of objects to annotate.

In one embodiment, the annotation platform 105 can identify the objects to annotate in each annotation session by randomly selecting or using some selection heuristic to select three points (e.g., pixels) in the image 201 and requesting the annotator to annotate the objects that contains the selected points. Examples of heuristics include, for instance, the annotation platform 105 choosing what appears to be a corner/edge/other feature of an object (e.g., of a building silhouette formed by building pixels), or choosing a point immediately adjacent to an already annotated object, etc. Additionally or alternatively, the annotation platform 105 retrieves external data or information to select the points. By way of example, the annotation platform 105 retrieves physical location data of some buildings in the image from the geographic database 115, based on the position and orientation data of a camera captured the image. In one embodiment, instead of pixel-based segmentation, the annotation platform 105 can apply other alternative image segmentation processes depending on the types of objects to be annotated. For example, objects with common shapes or colors can be capitalized on by simpler detection methods, such as using a flood fill algorithm to group pixels of rectangular features (such as windows and doors) into buildings, or to group animals in a limited range of colors, etc.

In one embodiment, the image 201 can be pre-processed using image segmentation (e.g., using any segmentation means known in the art) to identify pixels of the image 201 belonging to certain object categories. For example, the image 201 can be a street view image that depicts buildings, pedestrians, vehicles, etc. The pixel-based segmentation associates individual pixels with different classes of objects, such as building pixels, pedestrian pixels, vehicle pixels, etc., thereby facilitating later instance segmentation, e.g., distinguishing between two instances of the same kind of objects, such as buildings. In this way, the annotation applied to the selected pixel can also be applied to other pixels that have been segmented similarly.

In one embodiment, annotating or marking an object for annotation can include but is not limited to placing a bounding box around the object, drawing another shaped or free-form boundary around the object, and/or the like depicted in an annotation user interface. In another embodiment, marking or annotating an object comprises using a paintbrush tool or equivalent in an annotation user interface to paint over the visible parts of the object and no other pixels of the image. Additionally, the annotation platform 105 can present instructions, such as: “If two points are on the same object, that object is marked only once,” “Points mistakenly placed on the background or the wrong class of object may be ignored,” etc.

In one embodiment, the annotation sessions can continue until a stopping criterion 207 is met. For example, the stopping criterion can include but is not limited to determining that all objects (e.g., all 9 objects 203a-203i) have been annotated, a greater than a threshold percentage of pixels have been annotated, all objects over a certain size threshold have been annotated, etc. In embodiments in which image segmentation is performed, the stopping criterion 207 can include but is not limited to determine that there are no remaining unlabeled pixels in an segment/object class of interest (e.g., no remaining building-class pixels left in the image 201 to be associated with a building). As another example, the process may be stopped when the areas of remaining building-class pixels are below a threshold, e.g., buildings too far in the distance to be worth annotating.

As noted above, when training a machine learning model (e.g., a feature detection model) to detect objects or features depicted in images, an observation to be annotated can be an image with the objects or features to be identified by a human labeler. As mentioned, a large number of such observations or imagery generally is needed to be labeled in order to train a feature detection model to achieve target levels of detection accuracy.

In one embodiment, the system 100 assigns annotation tasks to workers thereby generating training data to train a machine learning system 101 that includes one or more feature detection models 103a-103n (also collectively referred to as feature detection models 103) to identify different features in observations of a phenomenon (e.g., images).

The machine learning system 101 may work in conjunction with the annotation platform 105 for presenting tasks for annotation sessions. In one embodiment, the annotation platform 105 performs pixel-based segmentation on an image 201 into various groups of object-pixels 203a-203i. The pixel-based segmentation of objects can be a standard operation of the machine learning system 101, the annotation platform 105, or a combination thereof.

In one embodiment, at least one of the feature detection models 103 can be trained to detect a class of objects of interest (e.g., buildings) in images. After the training, the feature detection model 103 is applied to classify a body of images to identify features/objects of interest. By way of example, the images can be collected from any source including but not limited to one or more camera-equipped vehicles 107a-107n (collectively 107) and/or user terminals 109a-109m (collectively 109) traveling in a road network. In one embodiment, the images can be collected by a computer vision system 111 over a communication network 113 as a part of a digital map making pipeline to generate a geographic database 115 of the found features/objects (e.g., location-based features such as, but not limited to, features/objects associated with roads, road furniture, points of interest, other vehicles, buildings, structures, terrain, etc.).

In another embodiment, the annotation platform 105 is incorporated into the machine learning system 101. In yet another embodiment, the annotation platform 105 is incorporated into the computer vision system 111.

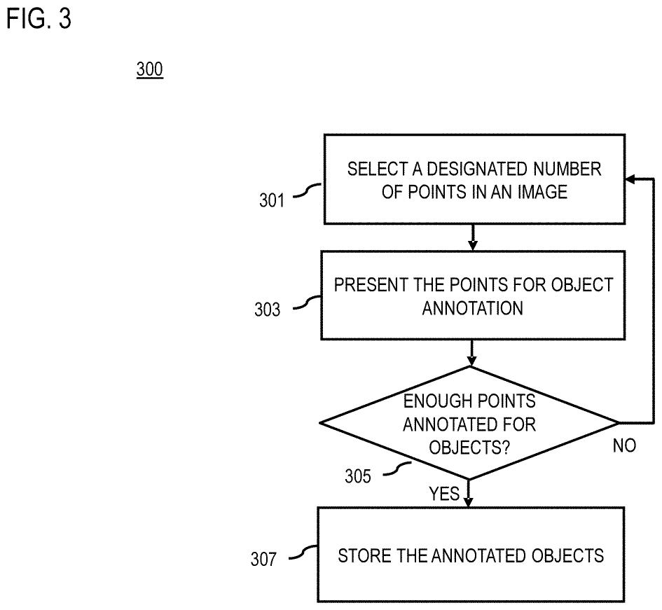

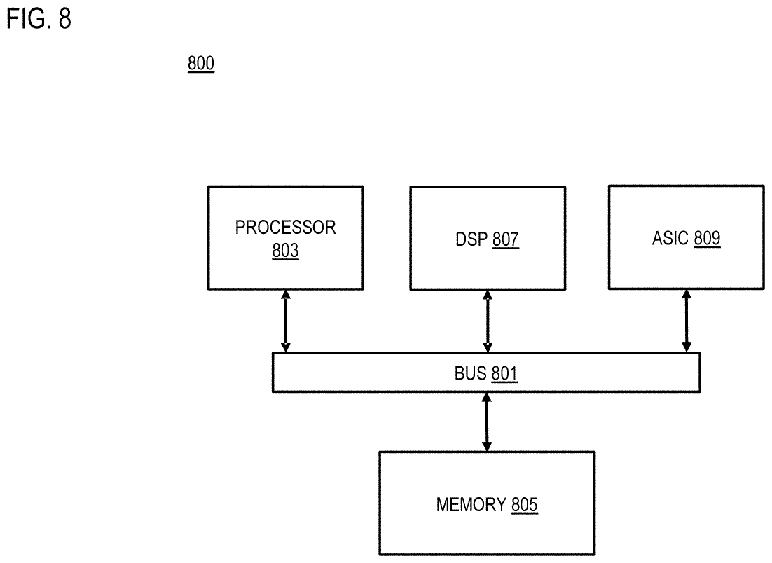

FIG. 3 is a flowchart of a process 300 for presenting an image annotation task, according to one embodiment. In one embodiment, the machine learning system 101, the annotation platform 105, and/or the computer vision system 111 may perform one or more portions of the process 300 and may be implemented in, for instance, a chip set including a processor and a memory as shown in FIG. 8. As such, the machine learning system 101, the annotation platform 105, and/or the computer vision system 111 can provide means for accomplishing various parts of the process 300. In addition or alternatively, a services platform 117 and/or one or more services 119a-119m (also collectively referred to as services 119) may perform any combination of the steps of the process 300 in combination with the machine learning system 101, the annotation platform 105, and/or the computer vision system 111, or as standalone components. Although the process 300 is illustrated and described as a sequence of steps, it is contemplated that various embodiments of the process 300 may be performed in any order or combination and need not include all of the illustrated steps.

In step 301, the annotation platform 105 selects a designated number of one or more points in an image. The designated number of points represents, for instance, the configured number of objects that is to be annotated in any given annotation session. By way of example, the annotation platform 105 selects at random a small number (e.g., 3 to 5, for example) of points in the image or observation instance. With respect to an image, the points can correspond to selected pixels or group of pixels in the image. As discussed above, random selection of the points is provided by way of illustration and not as a limitation. It is contemplated that the annotation platform 105 can use any process (e.g., including nonrandom processes) to select points in the image or observation to annotate. In one embodiment, the selection of the points can be based on a heuristic or rule as previously described.

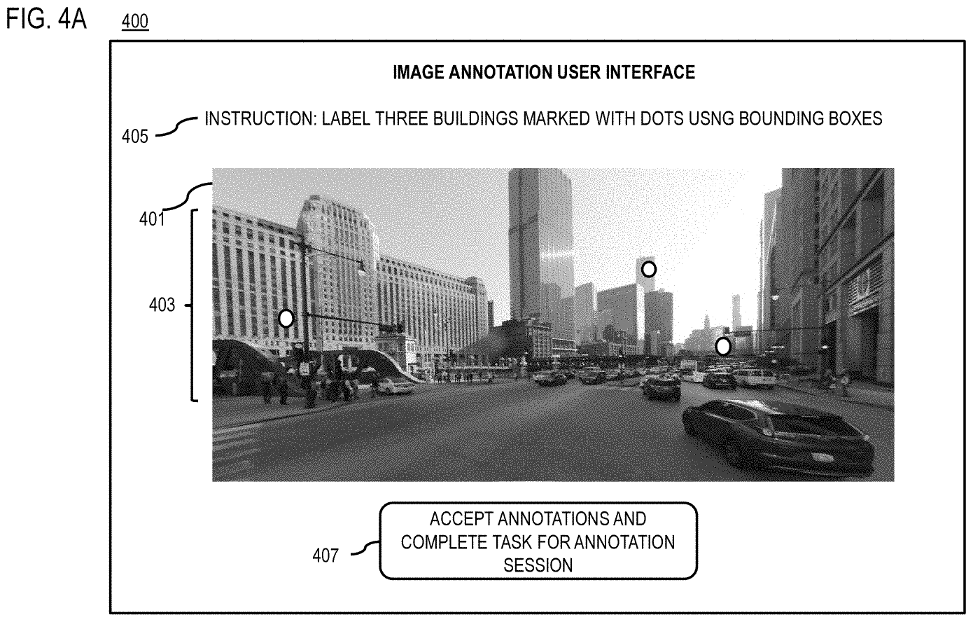

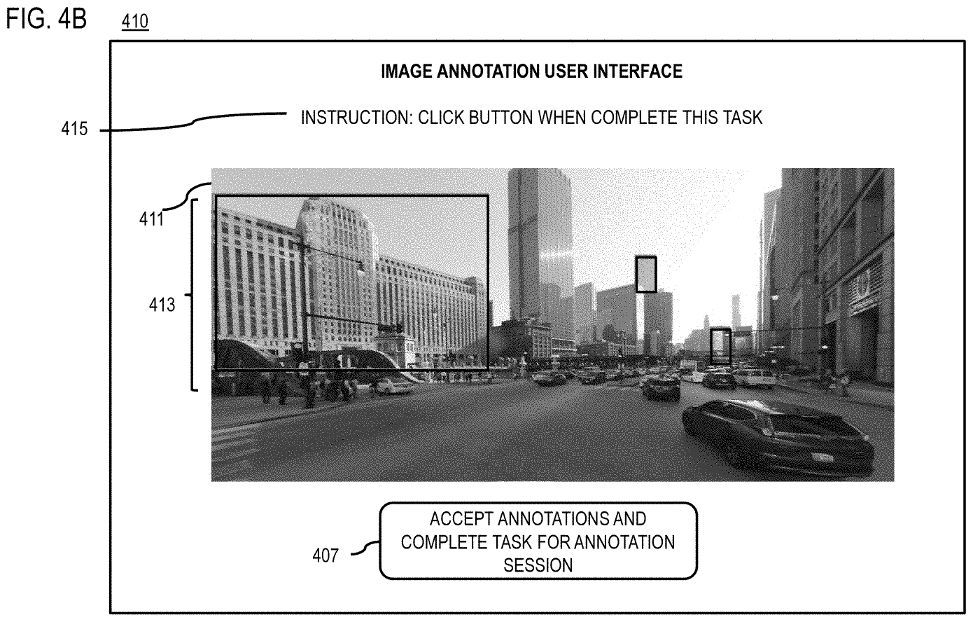

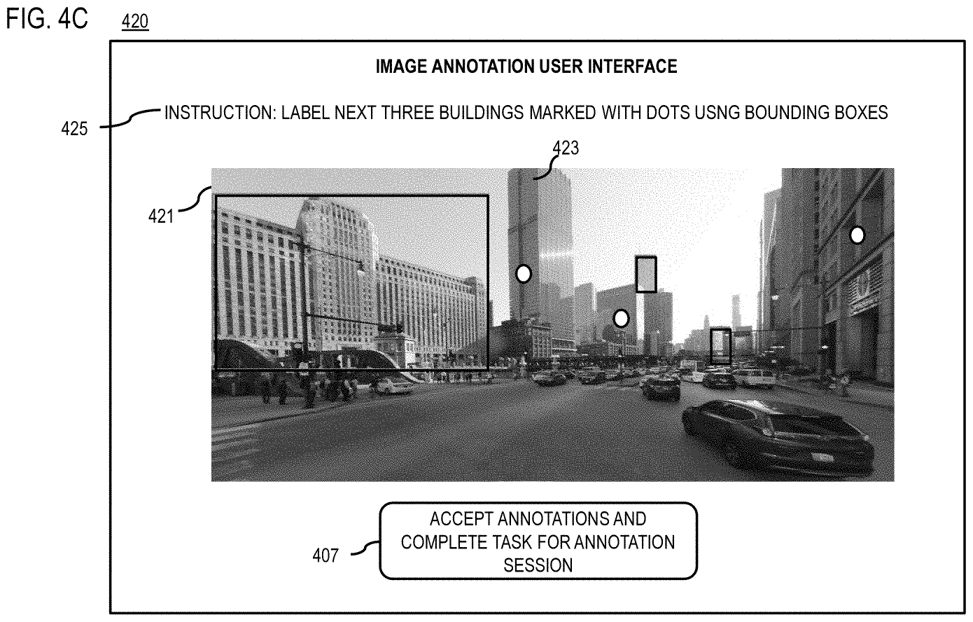

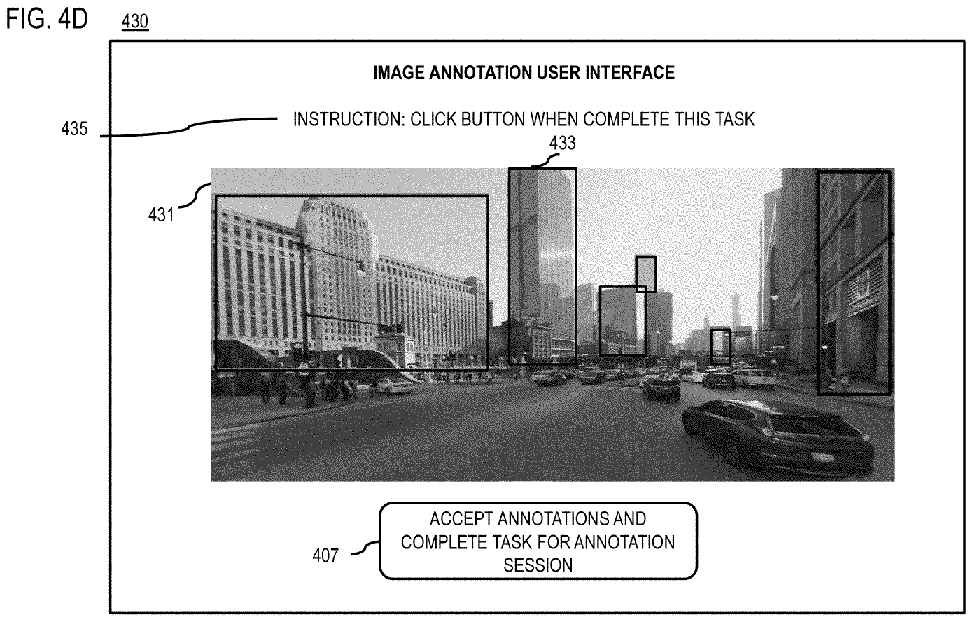

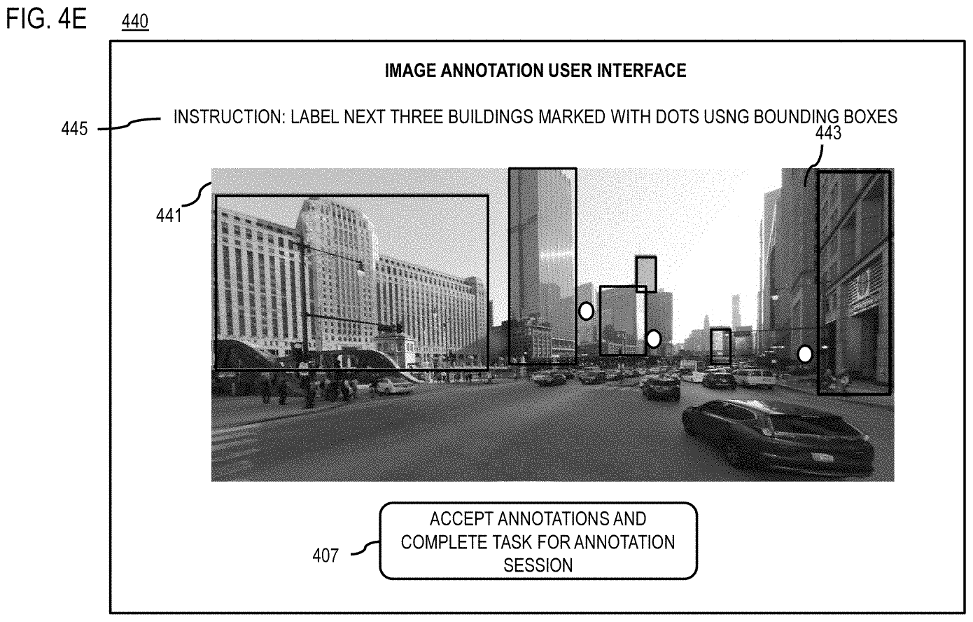

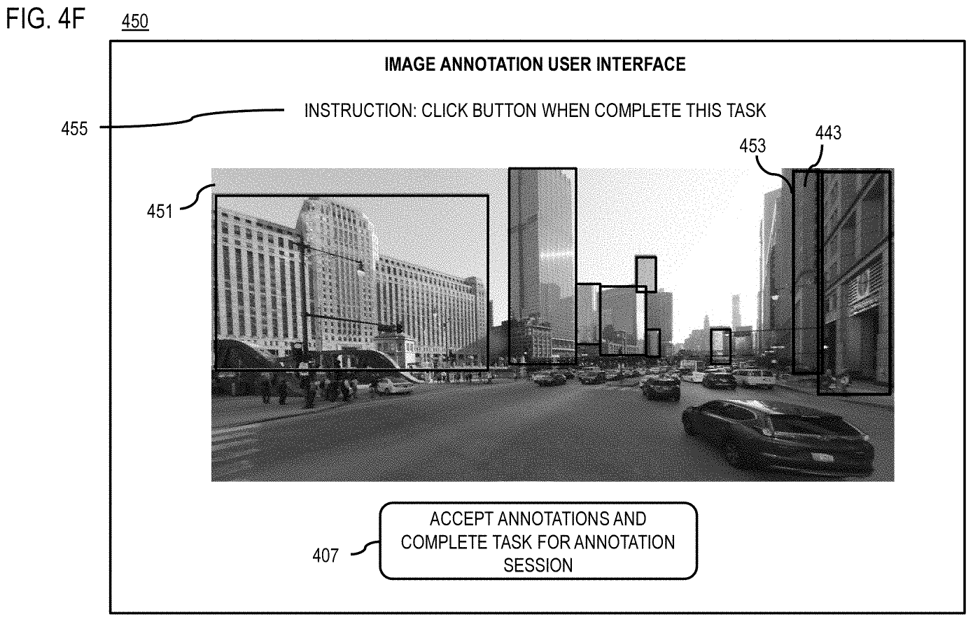

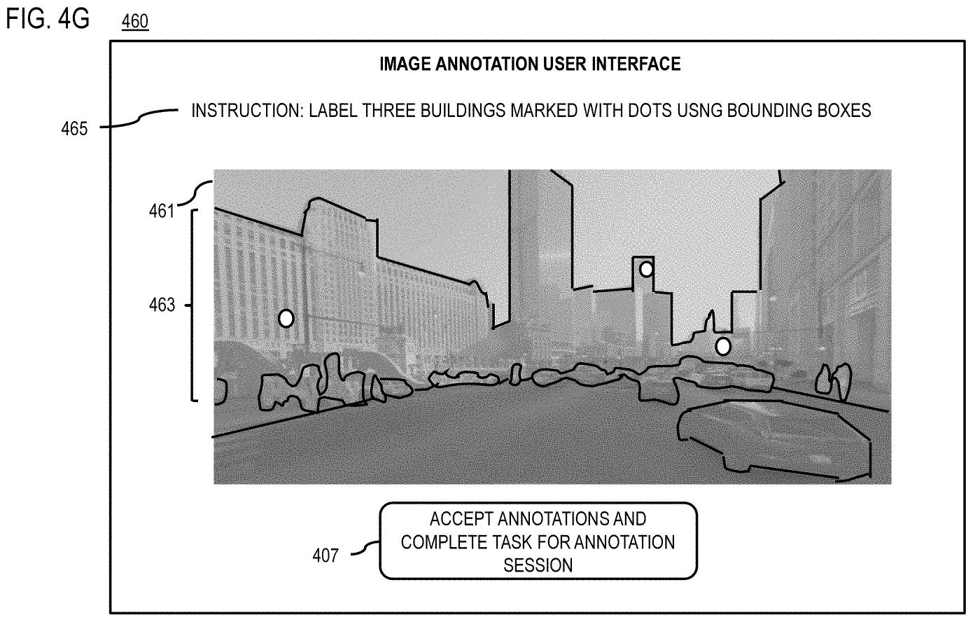

In step 303, the annotation platform 105 provides data for presenting a user interface indicating the one or more points in the image or observation comprising the designated number. The data, for instance, can indicate which pixel(s) in the image, which data point(s) in a data array, sampling point in a sound sample, probe point in a probe trajectory, etc. that are to rendered in a user interface to indicate corresponding objects/items to label. The user interface provides at least one user interface element for annotating one or more objects in the image corresponding to the designated number of the one or more points during an annotation session. The annotation or labeling includes any means for indicating the found feature or object including but not limited to tagging the image with a label, indicating the feature as a bounding box in the image, indicating pixels using a paintbrush tool, and/or the like. By way of example, FIG. 4A is a diagram illustrating a user interface 400 with an example image 401 for annotation, according to one embodiment.

In one embodiment, the annotation platform 105 can present the user interface 400 (e.g., on a computer or other user terminals 109 executing an annotation client 123 used by a human annotator) displaying the image 401 depicting objects of interest. By way of example, the system 100 provides a user interface or data for generating a user interface to enable a human annotator to label multiple objects of the same class/type (e.g., three buildings) at one session, to increase identification efficiency. In FIG. 4A, the image 401 is the street view of FIG. 2 depicting three markers on buildings (e.g., the first building 403 on the left side, etc.) to be annotated. Buildings are used as examples. Other structures on the street-level (e.g., signs, pedestrians, etc.), or any objects of interests in images (e.g., wine bottles, flowers, air balloons, etc.) can be processed similarly.

In another embodiment, the annotation platform 105 provides a user interface or data for generating a user interface to enable a human annotator to label multiple objects of different classes/types (e.g., one person, one dog, and one cat) at one session.

In this example, the user interface 400 presents an instruction 405 to the human annotator to “label three buildings marked with three markers using bounding boxes.” In one embodiment, the annotation platform 105 instructs the human annotator to mark a [single] entire object which contains each marker. Additional instructions may be displayed, such as “If two markers are on the same object, that object is marked only once,” “Markers mistakenly placed on the background or the wrong class of object may be ignored,” etc. In this example, ‘labelling’ an object is placing a bounding box around the object.

In another embodiment, ‘labelling’ an object is to use a paintbrush tool to paint over only the visible parts of the object and nothing else. Bounding-box annotations might miss an object. For example, when a human annotator puts a bounding box on a large building, the bounding box encloses a smaller building in front of the larger building such as the smaller building is masked and does not get identified. This problem can be avoided by asking the human annotator to use a paintbrush tool on the image rather than annotating a bounding box. However, it takes more effort and time for the human annotator to apply the paintbrush tool.

The annotation platform 105 then receives an input specifying an annotation label (e.g., a bounding box, etc.) for a point of the designated number of the one or more points, processes the image 401 to determine an object (e.g., the building 403) in the image that contains the point, and applies the annotation label to the object. Using an input device (e.g., mouse/cursor, touch input, etc.), the human annotator manually specifies an annotation label.

In FIG. 4B, a user interface 410 depicts an image 411 which overlays on FIG. 2 three bounding boxes drawn over buildings (e.g., a bounding box 413 over the first building 403 on the left side, etc.) by the human labeler. In this example, the user interface 410 presents an instruction 415 to the human labeler to “click button when complete this task.”

In step 305, the annotation platform 105 initiates an end of the annotation session based on determining that the one or more objects in the image have been annotated. In one embodiment, the annotation platform 105 automatically determines that the one or more objects in the image have been annotated based on the numbers of the bounding boxes. In another embodiment, the human labeler clicks a button 407 (“Accept annotations and complete task for annotation session”) to inform the annotation platform 105 the completion of the annotation session.

The annotation platform 105 performs at least one iteration of the selecting the designated number of one or more other points in the image for annotating during one or more subsequent annotation sessions.

By way of example, the next task can be another three points in the image 411. In FIG. 4C, a user interface 420 depicts an image 421 overlaying the street view of FIG. 4B with three dots on other buildings (e.g., including a building 423 in the middle, etc.) to be annotated. The algorithm can ensure the new dots are not inside the existing bounding boxes.

In this case, the user interface 420 presents an instruction 425 to the same human annotator to “label next three buildings marked with three dots using bounding boxes.” In another embodiment, the annotation platform 105 may present the new task to a different human annotator, in case that the first human annotator becomes unavailable.

In FIG. 4D, a user interface 430 depicts an image 431 which overlays on FIG. 4B three more bounding boxes drawn over buildings (e.g., a bounding box 433 over the building 423 in the middle, etc.) by the human labeler. In the second round, more bounding boxes are marked surrounding the buildings. In this example, the user interface 430 presents an instruction 435 to the human labeler to “click the button to complete this task.”

Thereafter, by selecting the button 407 (“Accept annotations and complete task for annotation session”), the human labeler can move on to the next task for another three points in the image 431. In FIG. 4E, a user interface 440 depicts an image 441 overlaying the street view of FIG. 4D with three dots on another three buildings (e.g., a second building 443 on the left, etc.) to be annotated. In this example, the user interface 440 presents an instruction 445 to the human annotator to “label next three buildings marked with three dots using bounding boxes.”

In FIG. 4F, a user interface 450 depicts an image 451 which overlays on FIG. 4D three more bounding boxes drawn over buildings (e.g., a bounding box 453 over the second building 443 on the left, etc.) by the human labeler. In this example, the user interface 450 presents an instruction 455 to the human labeler to “click the button to complete this task.” In this example, the iteration continues with the same class/type (e.g., buildings). In another embodiment, the iteration continues with different classes/types (e.g., vehicles, pedestrians, etc.) for subsequent sessions.

After the task is completed on the image, new points are chosen from the remaining points that have not already been marked as an object instance, and a new task is sent to the human annotator. The iteration can be stopped based on a stopping criterion. In one embodiment, the stopping criterion includes a threshold on an amount of unannotated points remaining in the image. By way of example, the iteration is stopped when the areas of remaining points are below a threshold, for example, buildings too far in the distance to be worth annotating (i.e., the remaining patches of building-associated pixels are too small) and skip asking workers about them. As another example, the process is repeated until there are no remaining points not associated with a building.

In another embodiment, the annotation platform 105 can determine whether the number of annotated images meets a threshold value. If there are not enough annotated images to meet the threshold, the annotation platform 105 can repeat the process 300 to annotate more images until the number of annotated images accumulated is enough to train a machine learning model. The threshold of the number of images can be based on a target accuracy of the machine learning model or other criteria specified by a system administrator, end user, etc.

In one embodiment, the designated number of the one or more points is selected randomly. In another embodiment, the designated number of the one or more points is selected according to a heuristic. By way of example, the heuristic is based on selecting a corner point, an edge point (e.g., of a building silhouette formed by the building pixels), and/or an adjacent point to another object (e.g., an already-annotated building). As other examples, the heuristic is based on external knowledge sources, such as map data of a scene represented in the image, camera position data of a camera capturing the image, camera orientation data of the camera capturing the image, or combination thereof. For example, the geographic database 115 contains physical location data of some buildings. The annotation platform 105 can combine the building location data with knowledge of a position and/or orientation of a camera that captured the image, to select dots/points for a task.

In yet another embodiment, the annotation platform 105 can pre-process or post-process the image using image segmentation to identify one or more objects in the image. The designated number of the one or more points can be selected based on the one or more objects identified in the image. By way of example, the annotation platform 105 selects at random a small number (3 to 5, for example) of points in the image that are classified as building-pixels.

By way of example, the annotation platform 105 can pre-process the image 401 of FIG. 4A with an initial feature detection algorithms, such as pixel-based segmentation that classifies each pixel into the given classes, such as building pixels, pedestrian pixels, etc. Such pixel-based segmentation techniques, e.g., powered by Convolutional Neural Networks (CNNs), can draw the boundaries of a group objects within an input image at the pixel level, such a row of buildings (e.g., on the left side of FIG. 4G), etc. In FIG. 4G, the machine learning system 101 selects at random a small number (3 to 5, for example) of points in a pixel-segmented image, i.e., building-pixels for an annotation session. In another embodiment, the output of the pixel-based segmentation is for internal processing without showing to a human annotator.

In another embodiment, the annotation platform 105 can select initial three points and/or any subsequent three points randomly or according to a heuristic as described above, then overlay the selected points on the output of the image segmentation. In FIG. 4G, a user interface 460 depicts an image 461 which overlays the output of the image segmentation on FIG. 4A, such different colors/shades representing different classes: buildings are green, cars are purple, etc.

In FIG. 4G, the user interface 460 isolates a row of buildings 463, other building clusters, vehicles, etc. from the background, and presents an instruction 465 to the human labeler to “click the button to complete this task.” The image segmentation output assists the human annotator to draw a boundary for a building within a cluster of buildings. By analogy, the output of the image segmentation can be overlaid over subsequent tasks, such as shown in FIG. 4C and/or FIG. 4E.

Instead of the pixel-based image segmentation, the annotation platform 105 can apply alternatives depending on the types of objects. For example, objects with common shapes or colors can be grouped by simpler detection methods, such as using flood fill algorithms to group pixels of rectangular features (such as windows and doors) into buildings, or to group animals in a limited range of colors, etc.

Rather than presenting the identical markers for different classes (e.g. building, vehicles, etc.), the annotation platform 105 can presents different makers specific for different classes, such a line for a building, a square for a street sign, etc. In one embodiment, the specific markers of different classes are selected according to a heuristic. In another embodiment, the specific markers can be generated, for example, using flood fill algorithms to group pixels mostly of the same color into a marker for identifying an object (e.g., a building). In this case, the specific markers of different classes start with one pixel and then grow by flood fill algorithms. Either way, there is a threshold for a marker size so a marker in one object does not go too far as to reach into adjacent objects in the image, when the objects share similar colors (e.g., a row of buildings). In these embodiments, different marker shapes provide different visual hints to the human annotator to identify objects of shapes similar to the marker shapes, thereby increasing labelling efficiency.

After a first task is completed on the image, new points are chosen from the remaining set of building-class pixels that have not already been marked as an object instance, and a new task is sent to the human annotator. This process is repeated until there are no remaining building-class pixels not associated with a building. The process may also be stopped if the areas of remaining building-class pixels are below a threshold: buildings too far in the distance to be worth annotating, for example.

The quality of pixel segmentation affects the labelling quality. When the pixel-based segmentation misses an object, the annotation platform 105 may not instruct the human annotator to annotate the object.

In another embodiment, the annotation platform 105 can pre-process or post-process the image using simpler detection methods than pixel-based segmentation, to capitalize objects with common shapes and/or colors, so as to identify the respective objects in the image. For example, buildings generally have rectangular features such as windows and doors, animals normally appear in a limited range of colors, etc. The annotation platform 105 can select rectangular feature points/markers to be labeled so as to identify buildings in an image.

In other embodiments, the annotation platform 105 takes tailored task formulating approaches, such as based on priority. By way of example, the annotation platform 105 selects markers to first identify a center of mass in a collection of pixels, to first identify a coherent structure (e.g., a blob) in the center or on one side, etc.

In step 307, the annotation platform 105 stores the annotated one or more objects whenever each task is completed. In another embodiment, the annotation platform 105 stored per each image that has been annotated or labeled with one or more objects of interest. In yet another embodiment, the annotation platform 105 stored a plurality of images that have been annotated or labeled with one or more objects of interest.

In one embodiment, the annotation platform 105 provides the designated number of the one or more points, and/or the annotated images as training data for training a machine learning model (e.g., a logistic regression model, Random Forest model, and/or any equivalent model). To create a well-trained machine learning or prediction model, the system 100 can use the embodiments described herein to create a high-quality training data set while minimizing associated costs, particularly, costs related to manual annotation.

By way of example, the annotation platform 105 can use the designated points/pixels and/or the annotated images to train a machine learning model to detect road features (e.g., signs, landmarks, buildings, etc.) and related identifying characteristics (e.g., corporate logos displayed on the signs, buildings, etc.), thereby more specifically identifying relevant map features. In other words, the precise localization of those features/objects within the image as training data can greatly assists training of a feature/object prediction model.

In another embodiment, the annotation platform 105 provides the designated points and/or annotated images to train the machine learning model that enables a range of new services and functions including autonomous driving. For example, with respect to autonomous driving, computer vision and computing power supporting object/feature detection and other related machine learning techniques have enabled real-time mapping and sensing of a vehicle's environment.

Although various embodiments are described with respect to real-world images, it is contemplated that the approach described herein may be used with synthetic images. Synthetic refers to the image having the feature or object artificially place or inserted into an image that originally does not depict the feature or object.

The embodiments described above are discussed with respect to determining object instances using a human-assisted process (e.g., via presentation of the images in a user interface for selection/verification). However, it is also contemplated that the images can in addition be determined using a fully automated processing pipeline. For example, instead of presenting the image for manual annotation, the annotation platform 105 processes the at least one subset of the plurality of images using one or more different image classifiers trained to detect at least one object from the image). This images classifier can double-check the images labelled by human annotators per task and/or per image. As with the image classifiers, the annotation platform 105 can also monitor the number of false labels made by each human annotator. When the number of false labels of one human annotator reaches a threshold, the annotation platform 105 can issue alerts of labelling performance of human annotators, such as to the respective human annotators, the relevant labelling service platforms, the relevant labelling service buyers, etc.

As mentioned, in addition to images, observations to be annotated can be data records or files representing or recording observations of a phenomenon that can be manually labeled with features or characteristics identified by a human labeler. The annotation platform 105 can similarly process other observations of a phenomenon, such as audio recordings, probe trajectories, etc., to present annotation tasks for features or characteristics identifiable by an observer, as the approach of presenting image annotation tasks. In one embodiment, the annotation platform 105 selects a designated number of one or more points in an observation instance. The designated number (e.g., 5) is a maximum number of the one or more points that is to be annotated in one annotation session. As discussed, the designated number of the one or more points can be selected randomly, selected according to a heuristic, or a combination thereof.

The observation instance can be any data array, and the points include data points of the data array. The above-discussed embodiments involve observation instances of images and data points of image pixels.

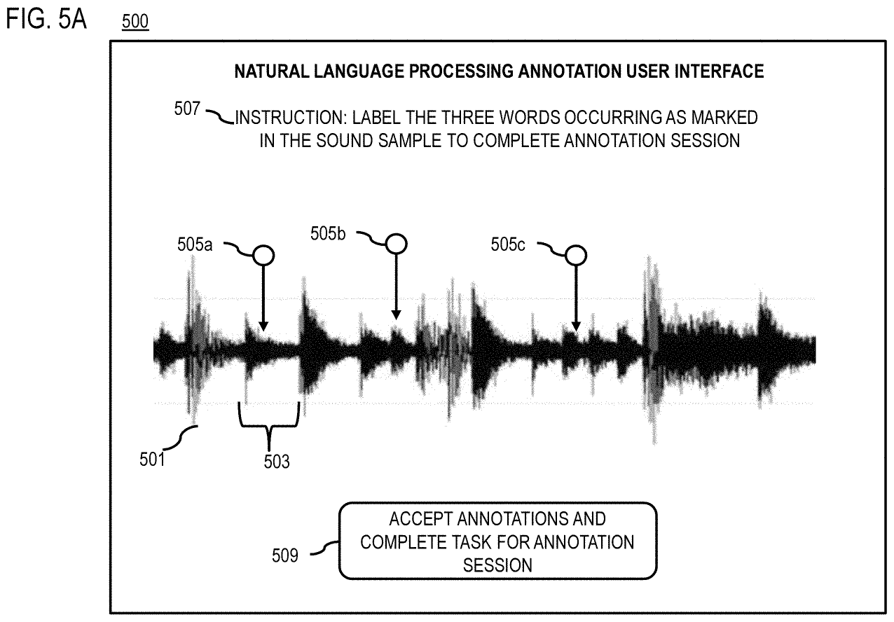

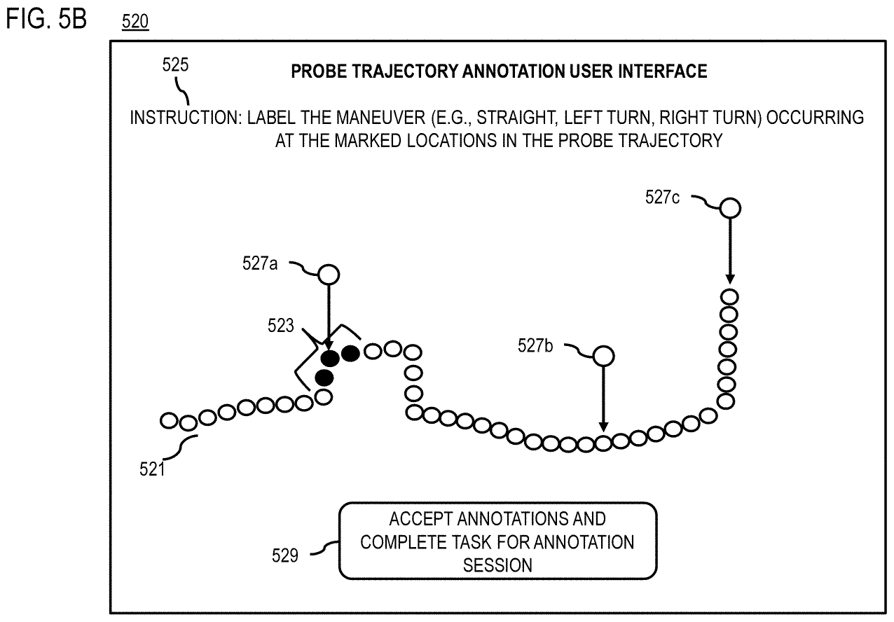

In another embodiment, the observation instance is a speech sound sample (e.g., a song recording, a speech, etc.), and the one or more points include one or more speech sound phonemes of the speech sound sample. A phoneme may be a speech sound and the smallest unit of sound, such as /b/, /d/, /a/, /e/, /zh/, /th/, etc. that can be combined into one word (e.g., “Hi!”), a word sound, or any sound unit (e.g., bird chirping sound) identifiable by human. FIG. 5A is a diagram of a user interface for presenting an audio annotation task, according to one embodiment. In FIG. 5A, a user interface 500 shows a spectrogram of a speech sound sample 501 with a plurality of speech sound phonemes to be annotated, for example, including a sound 503.

In FIG. 5A, the annotation platform 105 presents pointers 505a-505c to three speech sound phonemes to be annotated and an instruction 507 “Label the three words occurring as marked in the sound sample to complete annotation session.” Using fingers or an input device (e.g., mouse/cursor, touch input, etc.), the human annotator can mark starting points and end points of each identified word on the spectrogram of the speech sound sample 501. The worker can then click a button 509 (“Accept annotations and complete task for annotation session”) to indicate the completion of the annotation session. The annotation platform 105 iteratively selects three of the remaining points for more annotation sessions, until a stopping criterion, e.g., all the sound phonemes of the sample are classified into words. Thereafter, by way of example, the annotation platform 105 can use annotated sound data to train a machine learning model for voice recognition.

In another embodiment, the observation instance is a probe trajectory (e.g., a vehicle trajectory, etc.), and the one or more points include one or more probe points of the probe trajectory. FIG. 5B is a diagram of a user interface for presenting a trajectory annotation task, according to one embodiment.

In FIG. 5B, a user interface 520 shows a probe trajectory 521 with a plurality of waypoints to be annotated, for example, including a right turn 523. The annotation platform 105 presents pointers 527a-527c to three waypoints to be annotated and an instruction 525: “Label the maneuver (e.g., straight, left turn, right turn) occurring at the marked locations in the probe trajectory.” Using fingers or an input device (e.g., mouse/cursor, touch input, etc.), the human annotator can mark waypoints of the right turn 523, etc. The worker can then click a button 529 (“Accept annotations and complete task for annotation session”) to indicate the completion of the annotation session.

The iterative selecting of three other waypoints can be stopped based on a stopping criterion, e.g., all waypoints of the probe trajectory 521 are classified. Thereafter, by way of example, the annotation platform 105 can use annotated trajectory data to train a machine learning model to incrementally generate a road network and determine lane features (e.g., lane numbers, curvature, lane markings, lane lines, Botts' dots, reflectors, etc.), thereby more specifically identifying the relevant map features. Lane-level information is important for self-driving applications.

The approach of the various embodiments described herein provide for several advantages including but not limited to: (1) providing a consistent and predictable work amount per annotation task; (2) making each task simpler and more objective thereby increasing the label quality; (3) eliminating the need to describe to the human annotators how detailed and fine-grained they should be, as well as their subjective judgments; (4) providing work flexibility for the human annotators to control the length of a break between tasks; (5) compensating human annotators fairly per annotation task; (6) motivating the human annotators with the fair compensation and the workload control thereby increasing labelling quality and efficiency; (7) providing high-quality training data set to create a well-trained machine learning or prediction model while minimizing associated costs, particularly, costs related to manual annotation; and (8) evaluating and terminating label quality per human annotator to increase general labelling efficiency.

Returning to FIG. 1, as shown, the system 100 includes the machine learning system 101 for providing high-quality training data set to train a machine learning model according the various embodiments described herein. In some use cases, the system 100 can include the computer vision system 111 configured to use machine learning to detect objects or features depicted in images. For example, with respect to autonomous, navigation, mapping, and/or other similar applications, the computer vision system 111 can detect road features (e.g., lane lines, signs, etc.) in an input image and generate training data, according to the various embodiments described herein. In one embodiment, the machine learning system 101 includes a neural network or other equivalent machine learning model (e.g., Support Vector Machines, Random Forest, etc.) to detect features or objects. In one embodiment, the neural network of the machine learning system 101 is a traditional convolutional neural network which consists of multiple layers of collections of one or more neurons (e.g., processing nodes of the neural network) which are configured to process a portion of an input image. In one embodiment, the receptive fields of these collections of neurons (e.g., a receptive layer) can be configured to correspond to the area of an input image delineated by a respective a grid cell generated as described above.

In one embodiment, the machine learning system 101, the annotation platform 105, and/or the computer vision system 111 also have connectivity or access to a geographic database 115 which stores representations of mapped geographic features to compare against or to store features or objects detected according to the embodiments described herein. The geographic database 115 can also store representations of detected features and/or related data generated or used to generate training data for a machine learning model.

In one embodiment, the machine learning system 101, the annotation platform 105, and/or the computer vision system 111 have connectivity over a communication network 113 to the services platform 117 that provides one or more services 119. By way of example, the services 119 may be third party services and include mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 119 uses the output of the machine learning system 101 and/or of the computer vision system 111 (e.g., detected lane features) to localize a vehicle 107 or a user terminal 109 (e.g., a portable navigation device, smartphone, portable computer, tablet, etc.) to provide services 119 such as navigation, mapping, other location-based services, etc.

In one embodiment, the machine learning system 101, the annotation platform 105, and/or the computer vision system 111 may be a platform with multiple interconnected components. The machine learning system 101, the annotation platform 105, and/or the computer vision system 111 may include multiple servers, intelligent networking devices, computing devices, components, and corresponding software for providing parametric representations of lane lines. In addition, it is noted that the machine learning system 101, the annotation platform 105, and/or the computer vision system 111 may be a separate entity of the system 100, a part of the one or more services 119, a part of the services platform 117, or included within the user terminals 109 and/or vehicles 107.

In one embodiment, content providers 121a-121k (collectively referred to as content providers 121) may provide content or data (e.g., including geographic data, parametric representations of mapped features, etc.) to the geographic database 115, the machine learning system 101, the annotation platform 105, the computer vision system 111, the services platform 117, the services 119, the user terminals 109, the vehicles 107, and/or an annotation client 123 executing on the user terminals 109. The content provided may be any type of content, such as map content, textual content, audio content, video content, image content, etc. In one embodiment, the content providers 121 may provide content that may aid in the detecting and classifying of lane lines and/or other features in image data and estimating the quality of the detected features. In one embodiment, the content providers 121 may also store content associated with the geographic database 115, the machine learning system 101, the annotation platform 105, the computer vision system 111, the services platform 117, the services 119, the user terminals 109, and/or the vehicles 107. In another embodiment, the content providers 121 may manage access to a central repository of data, and offer a consistent, standard interface to data, such as a repository of the geographic database 115.

In one embodiment, the user terminals 109 may execute a software annotation client 123 to generate training data to train machine learning models according the embodiments described herein. By way of example, the annotation client 123 may also be any type of application that is executable on the user terminals 109, such as autonomous driving applications, mapping applications, location-based service applications, navigation applications, content provisioning services, camera/imaging application, media player applications, social networking applications, calendar applications, and the like. In one embodiment, the annotation client 123 may act as a client for the machine learning system 101, the annotation platform 105, and/or computer vision system 111 and perform one or more functions associated with presenting an annotation task alone or in combination with the machine learning system 101.

By way of example, the user terminals 109 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the user terminals 109 can support any type of interface to the user (such as “wearable” circuitry, etc.). In one embodiment, the user terminals 109 may be associated with the vehicles 107 or be a component part of the vehicles 107.

In one embodiment, the user terminals 109 and/or vehicles 107 are configured with various sensors for generating or collecting environmental image data (e.g., for processing by the machine learning system 101, the annotation platform 105, and/or the computer vision system 111), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the user terminals 109 and/or vehicles 107 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the user terminals 109 and/or vehicles 107 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the user terminals 109 and/or vehicles 107 may include GPS or other satellite-based receivers to obtain geographic coordinates from satellites 125 for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the machine learning system 101, the annotation platform 105, the computer vision system 111, the services platform 117, the services 119, the user terminals 109, the vehicles 107, and/or the content providers 121 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

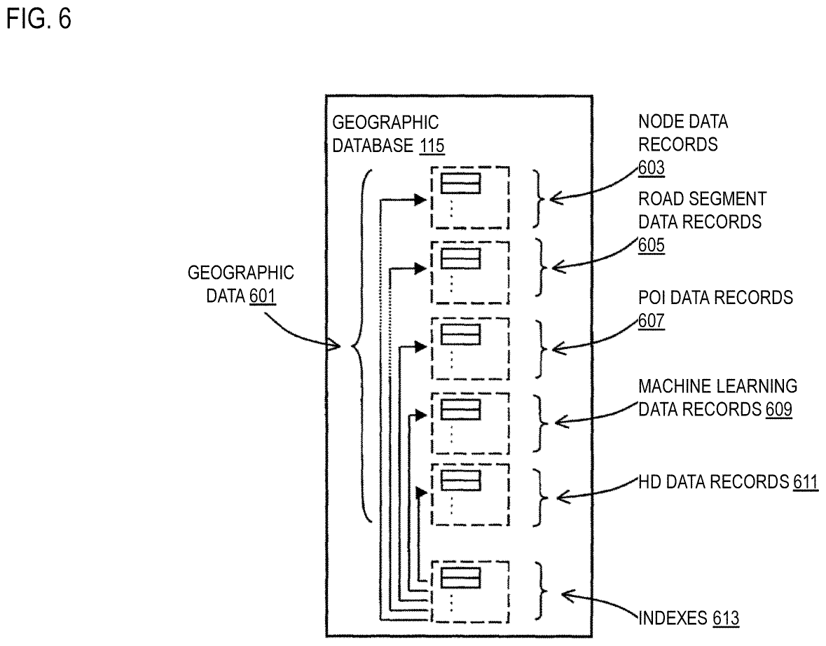

FIG. 6 is a diagram of a geographic database (such as the database 115), according to one embodiment. In one embodiment, the geographic database 115 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect billions of 3D points and model road surfaces and other map features down to the number lanes and their widths. In one embodiment, the HD mapping data (e.g., HD data records 611) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 603, road segment or link data records 605, POI data records 607, machine learning data records 609, HD mapping data records 611, and indexes 613, for example. More, fewer or different data records can be provided. In one embodiment, additional data records (not shown) can include cartographic (“cartel”) data records, routing data, and maneuver data. In one embodiment, the indexes 613 may improve the speed of data retrieval operations in the geographic database 115. In one embodiment, the indexes 613 may be used to quickly locate data without having to search every row in the geographic database 115 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 607. The geographic database 115 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 115 can also include machine learning data records 609 for storing training data, prediction models, annotated observations, computed featured distributions, sampling probabilities, and/or any other data generated or used by the system 100 according to the various embodiments described herein. By way of example, the machine learning data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the HD mapping data records 611 model road surfaces and other map features to centimeter-level or better accuracy. The HD mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 611 are divided into spatial partitions of varying sizes to provide HD mapping data to vehicles 107 and other end user devices with near real-time speed without overloading the available resources of the vehicles 107 and/or devices (e.g., computational, memory, bandwidth, etc. resources).

In one embodiment, the HD mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 611.

In one embodiment, the HD mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 107 and/or user terminals 109) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 107 or a user terminal 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for presenting an annotation task may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

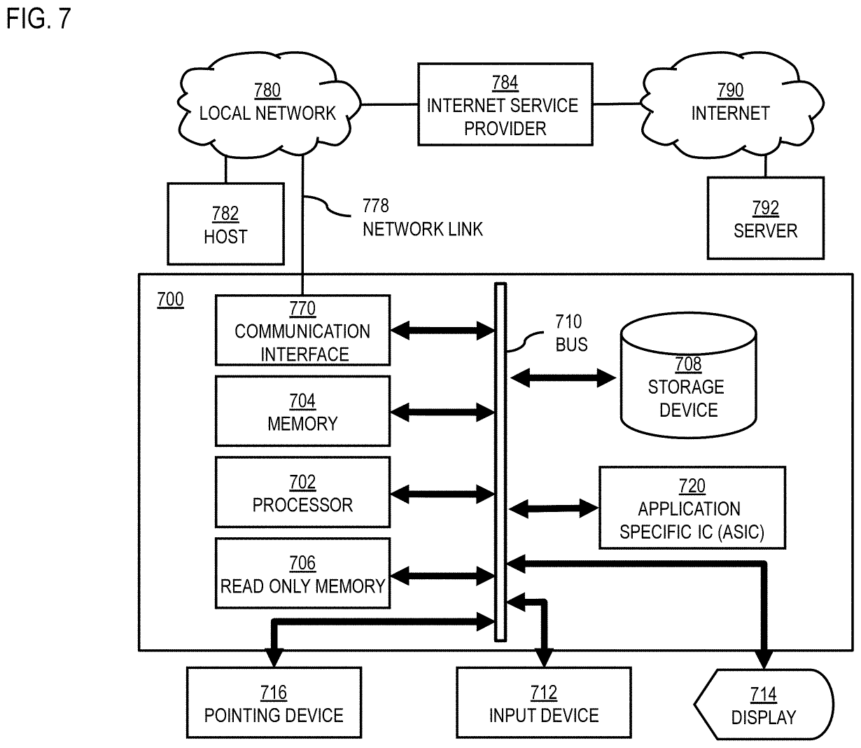

FIG. 7 illustrates a computer system 700 upon which an embodiment of the invention may be implemented. Computer system 700 is programmed (e.g., via computer program code or instructions) to present an annotation task as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to presenting an annotation task. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for presenting an annotation task. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for presenting an annotation task, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 113 for presenting an annotation task.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to present an annotation task as described herein and includes, for instance, the processor and memory components described with respect to FIG. 7 incorporated in one or more physical packages (e.g., chips). By way of example, a physical package includes a bulk arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to present an annotation task. The memory 805 also stores the data associated with or generated by the execution of the inventive steps.

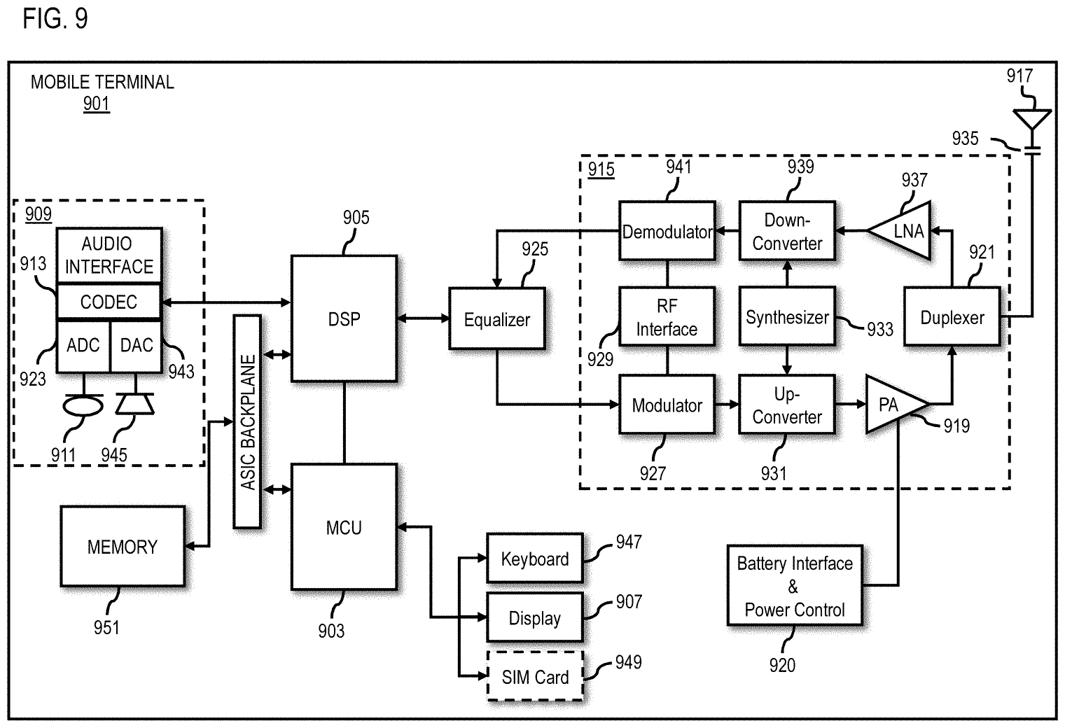

FIG. 9 is a diagram of exemplary components of a mobile terminal 901 (e.g., user terminals 109, vehicles 107, and/or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to present an annotation task. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for presenting an image annotation task comprising:
selecting a designated number of one or more points in an image;
providing data for presenting a user interface indicating the one or more points in the image comprising the designated number, wherein the user interface provides at least one user interface element for annotating one or more objects in the image corresponding to the designated number of the one or more points during an annotation session;
initiating an end of the annotation session based on determining that the one or more objects in the image have been annotated; and
storing the annotated one or more objects.

2. The method of claim 1, further comprising:
performing at least one iteration of the selecting the designated number of one or more other points in the image for annotating during one or more subsequent annotation sessions,
wherein the at least one iteration is stopped based on a stopping criterion.

3. The method of claim 2, wherein the one or more other points are selected from unannotated points remaining in the image.

4. The method of claim 2, wherein the stopping criterion includes a threshold on an amount of unannotated points remaining in the image.

5. The method of claim 1, wherein the designated number of the one or more points is selected randomly.

6. The method of claim 1, wherein the designated number of the one or more points is selected according to a heuristic.

7. The method of claim 6, wherein the heuristic is based on selecting a corner point, an edge point, an adjacent point to another object, or a combination thereof.

8. The method of claim 6, wherein the heuristic is based on map data of a scene represented in the image, camera position data of a camera capturing the image, camera orientation data of the camera capturing the image, or combination thereof.

9. The method of claim 1, further comprising:
processing the image using image segmentation to identify the one or more objects in the image,
wherein the designated number of the one or more points is selected based on the one or more objects identified in the image.

10. The method of claim 1, further comprising:
receiving an input specifying an annotation label for a point of the designated number of the one or more points;
processing the image to determine an object in the image that contains the point; and
applying the annotation label to the object.

11. The method of claim 1, further comprising:
providing the annotated designated number of the one or more points as training data for training a machine learning model.

12. An apparatus for presenting an annotation task, comprising:
at least one processor; and
at least one memory including computer program code for one or more programs,
the at least one memory and the computer program code configured to, with the at least one processor, cause the apparatus to perform at least the following,
select a designated number of one or more points in an observation instance;
provide data for presenting a user interface indicating the one or more points in the observation instance comprising the designated number, wherein the user interface provides at least one user interface element for annotating one or more objects in the observation instance corresponding to the designated number of the one or more points during an annotation session; and
initiate an end of the annotation session based on determining that the one or more objects in the observation instance has been annotated.

13. The apparatus of claim 12, wherein the observation instance is a data array, and wherein the one or more points include one or more data points of the data array.

14. The apparatus of claim 12, wherein the observation instance is an image, and wherein the one or more points include one or more pixels of the image.

15. The apparatus of claim 12, wherein the observation instance is a speech sound sample, and wherein the one or more points include one or more speech sound phonemes of the speech sound sample.

16. The apparatus of claim 12, wherein the observation instance is a probe trajectory, and wherein the one or more points include one or more probe points of the probe trajectory.

17. A non-transitory computer-readable storage medium for presenting an annotation task, carrying one or more sequences of one or more instructions which, when executed by one or more processors, cause an apparatus to at least perform the following steps:
determining an observation instance comprising one or more points, wherein one or more objects in the observation instance corresponding to the one or more points are to be annotated;
iteratively selecting a designated number of the one or more points for presentation in an annotation user interface across one or more annotation sessions, wherein the designated number is constant across the one or more annotation sessions; and
initiate an end of the one or more annotation sessions based on determining that the one or more objects in the one or more annotation sessions have been annotated.

18. The computer-readable storage medium of claim 17, wherein the designated number is a maximum number of the one or more points that is to be annotated in one annotation session of the one or more annotation sessions.

19. The computer-readable storage medium of claim 17, wherein the iterative selecting of the designated number of the one or more points is stopped based on a stopping criterion.

20. The computer-readable storage medium of claim 17, wherein the designated number of the one or more points is selected randomly, selected according to a heuristic, or a combination thereof.
